(19) United States
(12) Patent Application Publication
(10) Pub. No.: US 2024/0258041 A1
(43) Pub. Date: Aug. 1, 2024

(54) Low-Equivalent-Series-Resistance Capacitors with Solid-State Current Collectors Using Conductive Inks

(71) Applicant: Chipletz, Inc., Spicewood, TX (US)

(72) Inventors: Siddharth Ravichandran, Austin, TX (US); Michael Alfano, Austin, TX (US); Bryan Black, Austin, TX (US); Michael Su, Austin, TX (US)

(73) Assignee: Chipletz, Inc., Spicewood, TX (US)

(21) Appl. No.: 18/429,374

(22) Filed: Jan. 31, 2024

Related U.S. Application Data
(60) Provisional application No. 63/442,438, filed on Jan. 31, 2023.

(51) Int. Cl. H01G 9/042; H01G 9/00; H01G 9/055

(52) U.S. Cl. CPC H01G 9/0425; H01G 9/0032; H01G 9/055

(57) ABSTRACT

Structures and methods of forming a thin-film electrolytic capacitor without the conductive polymer, thus improving the ESR performance as well as the reliability of the capacitor. Thin-film electrolytic capacitor structures include sintered anode, oxide deposition, conductive polymer, conductive metal inks, and metal cathodes.

### CROSS-REFERENCE TO RELATED APPLICATIONS

This application is related to the following:

1. Provisional Application Ser. No. 63/442,438 filed 31 Jan. 2023 (“Parent Provisional”).

This application claims priority to the Parent Provisional, and hereby claims benefit of the filing date thereof pursuant to 37 C.F.R. § 1.78(a).

The subject matter of the Parent Provisional in its entirety is expressly incorporated herein by reference.

### FIELD OF INVENTION

Embodiments of the present invention are directed to semiconductor packaging and, more particularly, to improved current capacitor substrates for the specific purpose of improving the Equivalent Series Resistance (“ESR”) performance as well as the reliability of the capacitor.

### BACKGROUND

In general, in the descriptions that follow, the first occurrence of each special term of art that should be familiar to those skilled in the art of integrated circuits (“ICs”) and systems will be italicized. In addition, when a term that may be new or that may be used in a context that may be new, that term will be set forth in bold and at least one appropriate definition for that term will be provided. Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Fundamentally, and as is well understood by one of ordinary skill in the area of electronic circuit art, a capacitor is formed by layering a dielectric material between two metal electrodes, and an electrical charge proportional to the voltage is stored in the capacitor when a voltage is applied across the electrodes.

The capacitance is directly proportional to the surface area of the electrodes and dielectric constant of the dielectric, but inversely proportional to the distance between the two plates. Hence, a larger capacitance can be achieved by either: (i) increasing the dielectric constant; (ii) increasing the electrode surface area; or (iii) by decreasing the distance between the electrodes.

The Equivalent Series Resistance (“ESR”) of the capacitor is the internal resistance between the two terminals of the capacitor and it appears in series with the capacitance of the device. ESR is largely dependent on the loss tangent of the dielectric and inversely proportional to the surface area of the terminals and the conductivities of the terminal itself.

Increasing the surface area of the electrode allows one to increase capacitance and lower ESR at the same time. As is understood, one common method of achieving the same is by roughening the electrode (typically anode) by chemically or physically etching before the dielectric layer is formed/deposited. Another method of achieving this is to sinter powder of electrode metal together to form snowball stacks thus resulting in an increase in the surface area over a flat surface.

Once the first electrode is formed, a thin layer of dielectric, i.e., thin oxides, ceramic, Barium-Strontium Titanate, etc., is either grown or deposited. As is understood, one approach to growing the oxide film is a process called forming or anodization where the oxide is grown on the electrode submerged in an electrolytic solution by applying a voltage between the electrode and a calibration electrode across the electrolyte. Another common approach that is well understood may be to deposit thin layers of dielectric by physical vapor deposition, chemical evaporation, atomic layer deposition, printing, screening, wetting, etc.

To form a second electrode that can conform to the oxide layer on the first electrode that has been roughened, typically an electrolyte, e.g., electrolytic solution plus polymer, a conductive polymer, etc., is used as the second electrode, i.e., the cathode. Subsequently, additional conductive layers (typically metals) are then used to form the terminal to the cathode.

In state-of-the-art polymer capacitors, the conductive polymer may be dip coated or spray coated or squeegeed into the porous/roughened oxide network to capture the high surface area. Since the viscosity of the conductive polymers can be tuned, they provide the advantage of filling the porosity. However, many coats of this polymer may be required to achieve a stable current collector stack of the cathode. The thickness of the added polymer results in higher ESR of the capacitor. To form a metallic terminal there between, more interfaces such as carbon and thin layers of Ti and Cu are required to transition from the conductive polymer towards a metallic terminal. Adding many interfaces results in an increased interfacial resistance, which further increases ESR.

Another disadvantage to conductive polymers is the sensitivity to moisture absorption, hence limiting the use of traditional electroplating (which require wet plating baths). This forces the use of highly resistive metallic pastes or solder-like materials to form the terminal metal, which also increases ESR. Conductive polymers typically oxidize in the presence of oxygen and the resulting degradation increases the resistivity of the material. This effect is accelerated by elevated temperatures, and hence polymer capacitors degrade irreversibly at operating temperatures >130 C resulting in a reliability challenge in applications with high processing or operating temperatures, specifically semiconductor packages that may have such capacitors embedded in the package substrate or printed circuit board.

Therefore, there is a need for a thin-film electrolytic capacitor without the conductive polymer, thus improving the ESR performance as well as the reliability of the capacitor. In particular, we submit that such a method and apparatus should provide performance generally comparable to the best prior art techniques but more efficiently than known implementations of such prior art techniques.

### BRIEF SUMMARY OF THE INVENTION

According to one embodiment, a stacked polymer-free electrolytic capacitor comprising a first electrode comprised of a first metal, a dielectric deposed on the first electrode, and a second electrode deposed formed on the dielectric, the second electrode comprising a metal-organic decomposition ink.

According to a different embodiment, a stacked polymer-free electrolytic capacitor comprising a first electrode comprised of a first metal, a dielectric deposed on the first electrode, a conductive polymer deposed on the dielectric, and a second electrode deposed formed on the dielectric, the second electrode comprising a metal-organic decomposition ink.

According to one embodiment, a method of fabricating a cathode stack comprising a metallic cathode, comprising the steps of: increasing the surface area of a first electrode by way of chemical etching; dielectric growth through anodization of the first electrode; forming single or multi-coat metallic second electrode by way of spraying conductive ink to fill the nooks and crannies of oxide coated first electrode.

According to a different embodiment, a method of fabricating a cathode stack comprising a metallic cathode, comprising the steps of: increasing the surface area of a first electrode by way of sintering of metal particles to form first electrode; dielectric growth through anodization of the first electrode; forming single or multi-coat metallic second electrode by way of dipping first electrode into conductive ink to fill the nooks and crannies of oxide coated first electrode; coating with PVD or CVD of a second metal.

According to a different embodiment, a method of fabricating a cathode stack comprising a metallic cathode, comprising the steps of: increasing the surface area of a first electrode by way of trenching through RIE of core; PVD or CVD with electroplating of first electrode; dielectric deposition through PVD or CVD of the first electrode; forming single or multi-coat metallic second electrode by way of inkjet printing conductive ink into the nooks and crannies of oxide coated first electrode.

### BRIEF DESCRIPTION OF THE SEVERAL VIEWS OF THE DRAWINGS

FIG. 1 illustrates, in diagrammatic form, two options based on formation approach of first electrode for the current state of the art with polymeric electrolytic capacitors, according to some embodiments;

FIG. 2 illustrates, in diagrammatic form, a state-of-the-art cathode stack in polymer electrolytic capacitor versus a cathode stack comprising a metallic cathode, according to some embodiments;

FIG. 3 illustrates, in diagrammatic form, an alternate example of a state-of-the-art cathode stack in polymer electrolytic capacitor versus a cathode stack comprising a metallic cathode, according to some embodiments;

FIG. 4 illustrates, in flow diagram form, an exemplary process flow to build an integrated capacitor with vertical power delivery utilizing a capacitor substrate according to some embodiments;

FIG. 5 illustrates, in diagrammatic form, an exemplary flow using the polymer free capacitor process to build an integrated capacitor with vertical power delivery, according to some embodiments;

FIG. 6 illustrates, in diagrammatic form, an exemplary method of forming stacked multi-layer capacitor substrate for developing stacked thin-film capacitors with lower ESR, according to some embodiments;

FIG. 7 illustrates, in diagrammatic form, a state-of-the-art cathode stack in polymer electrolytic capacitor versus a cathode stack comprising a metallic cathode, according to some embodiments; and

FIG. 8 illustrates, in diagrammatic form, an alternate example of a state-of-the-art cathode stack in polymer electrolytic capacitor versus a cathode stack comprising a metallic cathode, according to some embodiments.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

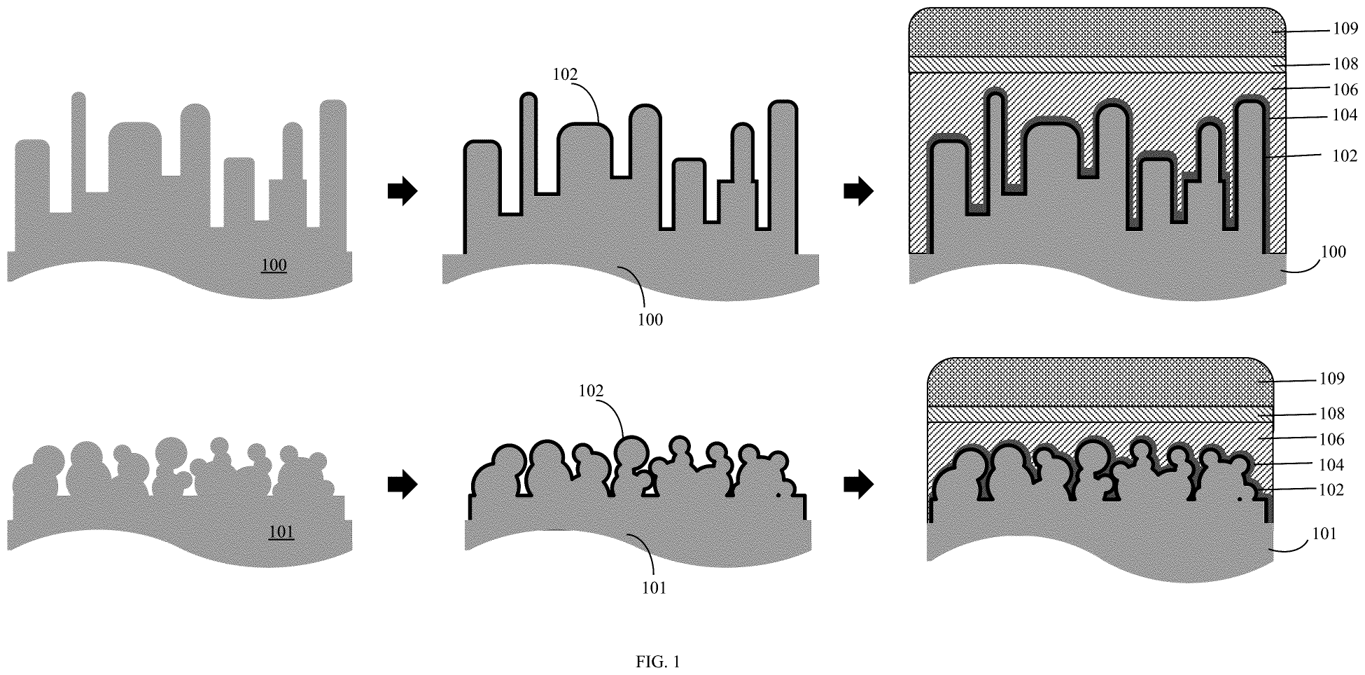

FIG. 1 illustrates two versions of a state-of-the-art polymeric capacitors wherein the conductive polymer is formed according to current processes. The anode is either first roughened 100 or sintered 101, and oxide 102 is then deposited or grown on the expanded anode surface area 100, 101. The first layer of conductive polymer 104 is deposited above the oxide region 102, followed by repeated layers of conductive polymer 106 to reach desired thickness. The metal cathode 109 is then deposited using a metal-epoxy composite paste 108. Other embodiments are anticipated.

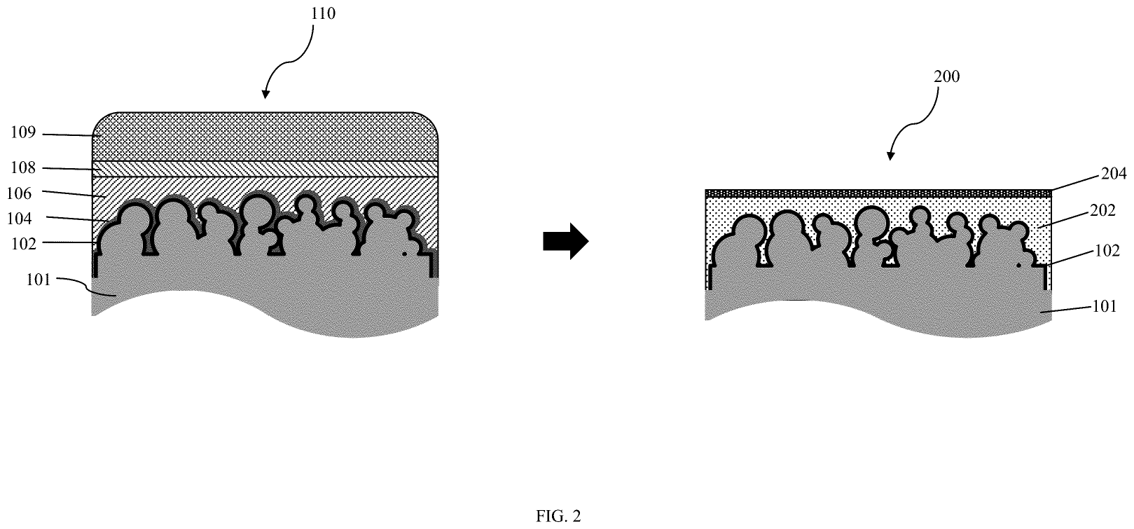

FIG. 2 illustrates, in diagrammatic form, a state-of-the-art cathode stack in polymer electrolytic capacitor with a sintered anode 101 versus a cathode stack comprising a metallic cathode 200, according to some embodiments. The polymer cathode 110 may be formed according to FIG. 1. The metallic cathode 200 comprises a sintered anode 101, oxide 102 deposited or grown on the expanded anode surface 101, a first layer of conductive ink 202 and may be followed by subsequent layers of conductive ink 204. Conductive ink 204 may able be a top-level metal seed, i.e., a copper (Cu) seed, is deposited by way of PVD, CVD, electroless plating, or printing/depositing another coat of particle-free ink. Conductive ink 204 could also be the final terminal of the capacitor device.

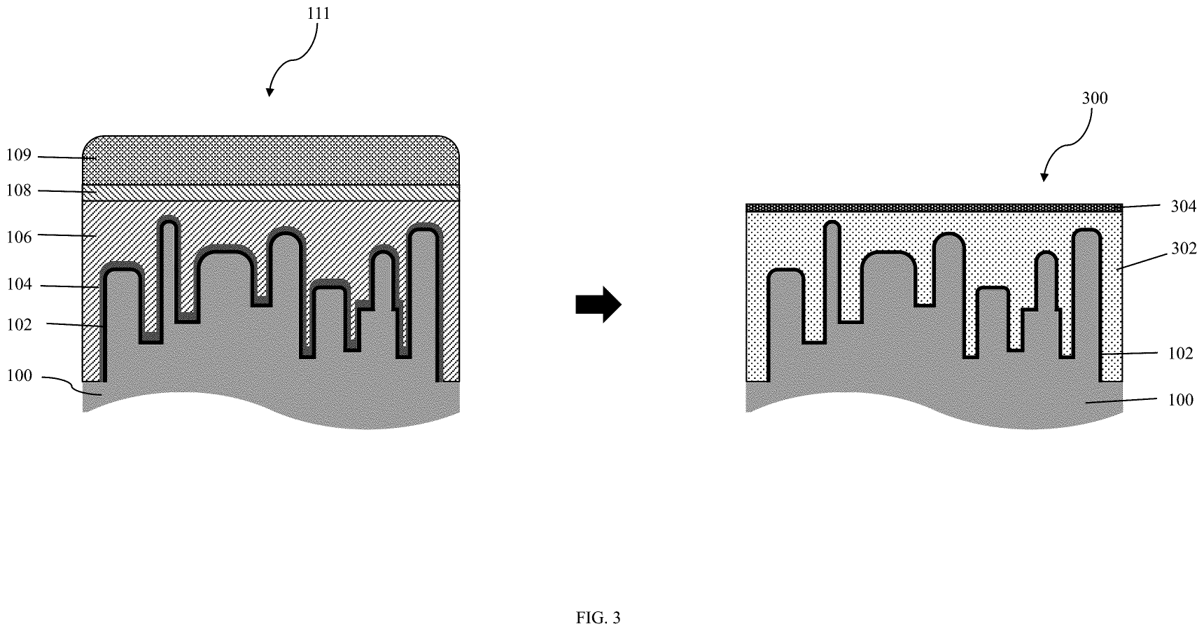

FIG. 3 illustrates, in diagrammatic form, an alternate example of a state-of-the-art cathode stack in polymer electrolytic capacitor with a roughened anode 100 versus a cathode stack comprising a metallic cathode 300, according to some embodiments. The polymer cathode 111 may be formed according to FIG. 1. The metallic cathode 300 comprises a roughened anode 100, oxide 102 deposited or grown on the expanded anode surface 100, a first layer of conductive ink 302 and may be followed by subsequent layers of conductive ink 304. Conductive ink 304 may able be a top-level metal seed, i.e., a copper (Cu) seed, is deposited by way of PVD, CVD, electroless plating, or printing/depositing another coat of particle-free ink. Conductive ink 304 could also be the final terminal of the capacitor device.

To get a fully metallic cathode stack there are many ways to achieve the outcome such as Atomic Layer Deposition (“ALD”), Physical Vapor Deposition (“PVD”), Chemical Vapor Deposition (“CVD”), dispensing metallic inks, etc. PVD and CVD are well established for a wide range of metal types, but they may not be optimal to get a uniform coating in high aspect ratio nooks and crannies of the porous network. ALD on the other hand might achieve such uniform coatings on the nooks and crannies but are extremely expensive and may have limitations on the types of metals used. Conductive inks on the other hand may be a lot cheaper, and can be deposited in a wide variety of methods, e.g., screen printing, dip coating, spray coating, etc.

Conductive inks can be categorized largely into two types, nanoparticle suspension ink and particle-free conductive inks. Particle-free conductive inks could be used to form metallic (eg. Silver, Gold, Copper, Platinum, Palladium, Nickel, etc.) or conducting oxides (eg. Indium-Tin-Oxide or ITO, doped Zinc Oxide, etc.) or conducting nitrides (eg. Titanium Nitride or TiN, etc.). The particle-free conductive inks are based on ionic precursors that decompose into conductive features upon deposition and/or curing or sintering. In the case of metallic particle-free inks, these inks are also known as Metal-Organic Decomposition (MOD) inks. There are two major issues in using nanoparticle inks as a replacement for conductive polymers for this purpose.

The particles in these inks tend to be larger in size to reach all the nooks and crannies of the porous network. The particles may also block some of these pores leaving a lot of the network underutilized. This will result in a lower active surface area of the capacitor and thus result in higher ESR and lower capacitance. Typically, nanoparticle-based conductive inks have particles dispersed in an insulating polymeric medium which again results in increased resistivity and high-temperature related reliability challenges.

Nanoparticle inks also do have many surfactants to create uniform dispersion of particles while preventing aggregation. These impact the metal loading of the ink and hence the fundamental conductivities of the ink. This also limits the methods to apply these inks for the purpose of forming the cathode.

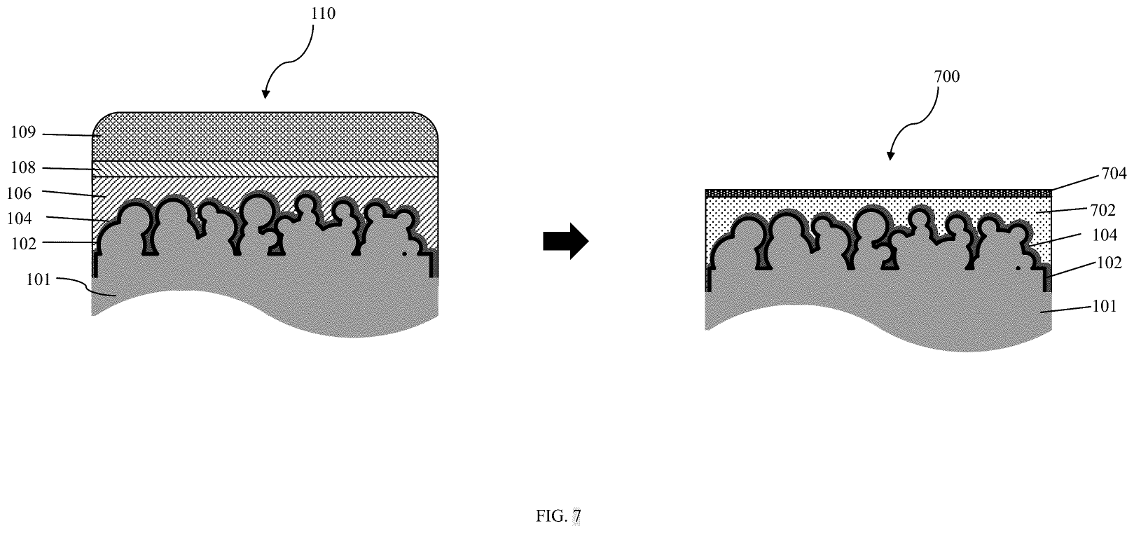

FIG. 7 illustrates, in diagrammatic form, another state-of-the-art cathode stack in polymer electrolytic capacitor with a sintered anode 101 versus a cathode stack comprising a metallic cathode 200, according to some embodiments. The polymer cathode 110 may be formed according to FIG. 1. The metallic cathode 700 comprises a sintered anode 101 and oxide 102 deposited or grown on the expanded anode surface 101. A first layer of conductive polymer 104 is deposited above the oxide region 102. Next, a first layer of conductive ink 702 and may be followed by subsequent layers of conductive ink 704. Conductive ink 704 may able be a top-level metal seed, i.e., a copper (Cu) seed, is deposited by way of PVD, CVD, electroless plating, or printing/depositing another coat of particle-free ink. Conductive ink 704 could also be the final terminal of the capacitor device.

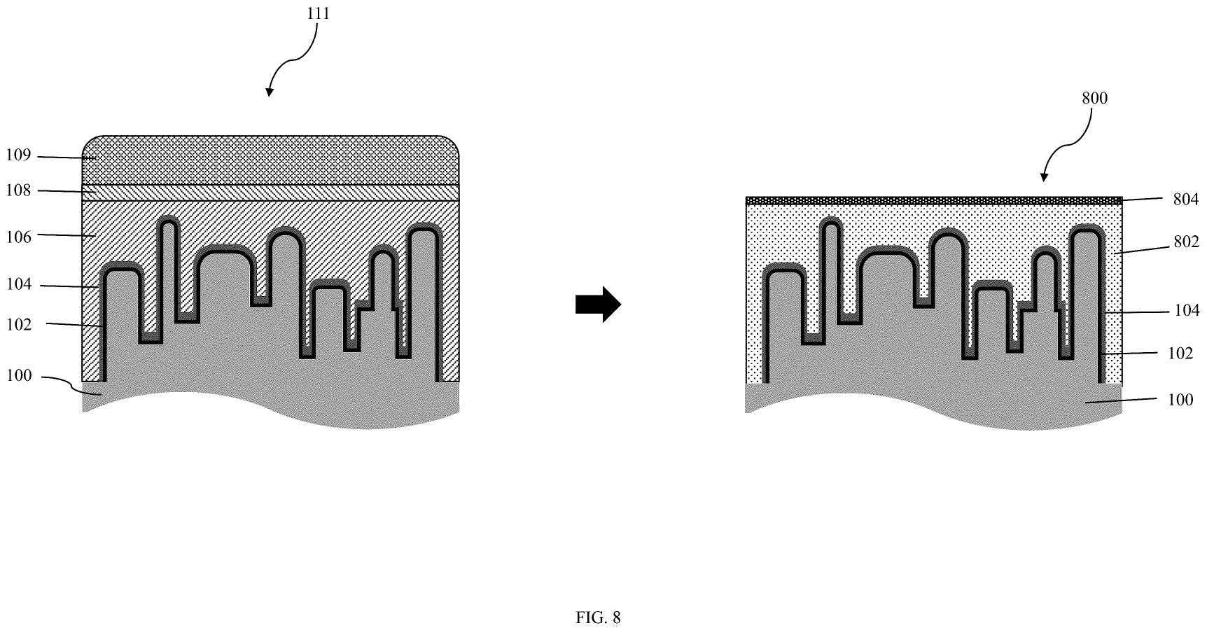

FIG. 8 illustrates, in diagrammatic form, another alternate exemplary state-of-the-art cathode stack in polymer electrolytic capacitor with a roughened anode 100 versus a cathode stack comprising a metallic cathode 800, according to some embodiments. The polymer cathode 111 may be formed according to FIG. 1. The metallic cathode 800 comprises a roughened anode 100, oxide 102 deposited or grown on the expanded anode surface 100. A first layer of conductive polymer 104 is deposited above the oxide region 102. A first layer of conductive ink 802 and may be followed by subsequent layers of conductive ink 804. Conductive ink 804 may able be a top-level metal seed, i.e., a copper (Cu) seed, is deposited by way of PVD, CVD, electroless plating, or printing/depositing another coat of particle-free ink. Conductive ink 804 could also be the final terminal of the capacitor device.

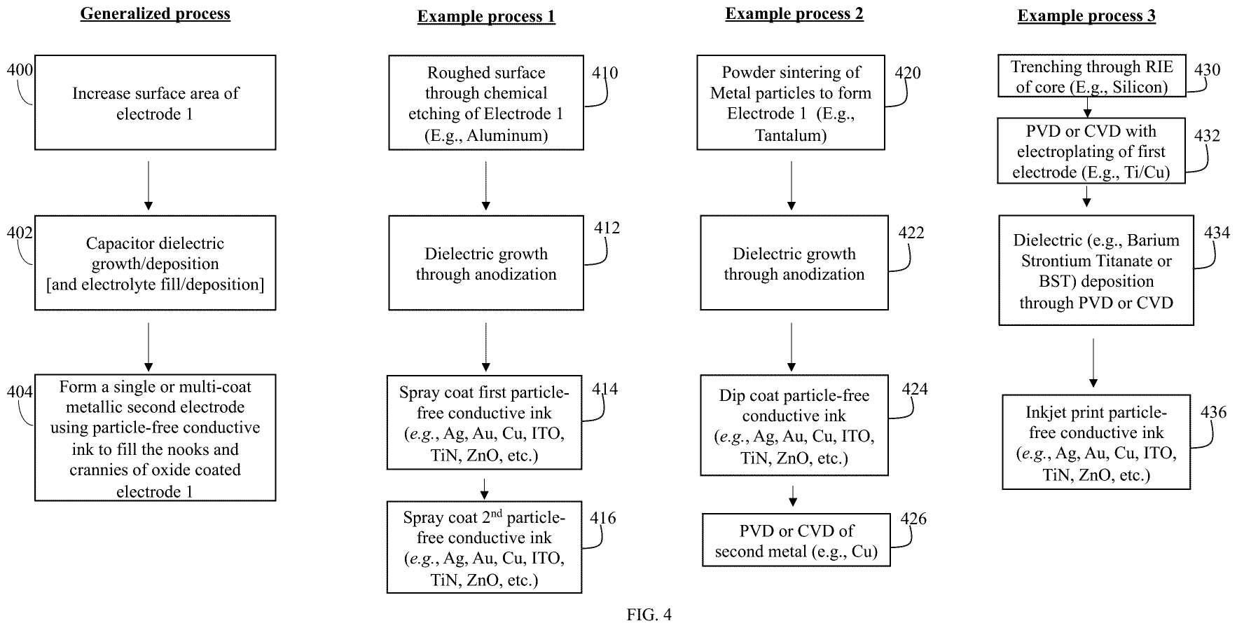

In general, FIG. 4 illustrates a process of increasing the surface area of a first electrode 400, depositing or growing the dielectric on the increased surface area of electrode 1 402, and forming the second electrode using particle-free conductive ink 404. By way of example, and without limitation, as illustrated in FIG. 4, increasing the surface area of electrode 1 may be perform by roughing the surface of electrode 1 by way of chemical etching 410 as shown in example process 1 of FIG. 4, sintering powdered metal particles to form the expanded surface area of electrode 1 420 as shown in example process 2 of FIG. 4, or trenching through reactive ion etching (“RIE”) of the core 430, e.g., silicon and subsequently PVD or CVD with electroplating of first electrode 432 as shown in example process 3 of FIG. 4. Likewise, by way of example, and without limitation, as illustrated in FIG. 4, depositing or growing the dielectric on the increased surface area of electrode 1 may be performed by growth through anodization 412, 422 as illustrated in example process 1 and 2 of FIG. 4, or by dielectric deposition 434, e.g., barium strontium titanate (“BST”), through PVD or CVD. The final more generalized step of forming the second electrode using particle-free conductive ink may be performed by spray coating multiple coats of particle-free conductive ink 414, 416, e.g., Ag, Au, Cu, ITO, TiN, etc., as illustrated in example process 1 of FIG. 4, dip coating with particle-free conductive ink 424 and PVD or CVD of second layer metal 426, e.g., Cu, as illustrated in example process 2 of FIG. 4, or by inkjet print using particle-free conductive ink 436 as illustrated in example process 3 of FIG. 4. Other embodiments are anticipated.

Referring back to FIG. 7 and FIG. 8, these exemplary embodiments illustrate versions having a thin coating of the conductive polymer prior to putting the conductive ink down. This this coating of conductive polymer may be useful in some applications where the process of anodization has a predilection for developing defects in the dielectric oxide layer. Such defects may be pinholes, and may result in and electrical short developing between anode and cathode thus resulting in increased leakage current that is non-ideal for a capacitor. In some embodiments, conductive polymers have been shown to have an advantageous characteristic of self-healing, e.g., where the polymer coating in the pin-holes “burn-off”, due in part to the heating from a high-resistance path for leakage current through the pin-hole defects, and leave a void or “open” in the polymer. This is what is referred to as “self-healing”, reducing the capacitor's leakage current. As discussed earlier, multiple coats of conductive polymer is typically applied to the “fill” the porosity starting from a low-viscosity coat that gets to the nooks and crannies and increasing the viscosity in subsequent coats to fill the porosity while keeping ESR low. The claimed approach limits the use of conductive polymer to 1-2 coats, e.g., just enough to ensure “self-healing”, followed by conductive ink fill the porosity. Such an approach reduces the ESR of the capacitor, by eliminating the thickness or volume of conductive polymer used) while ensuring the leakage current is minimized.

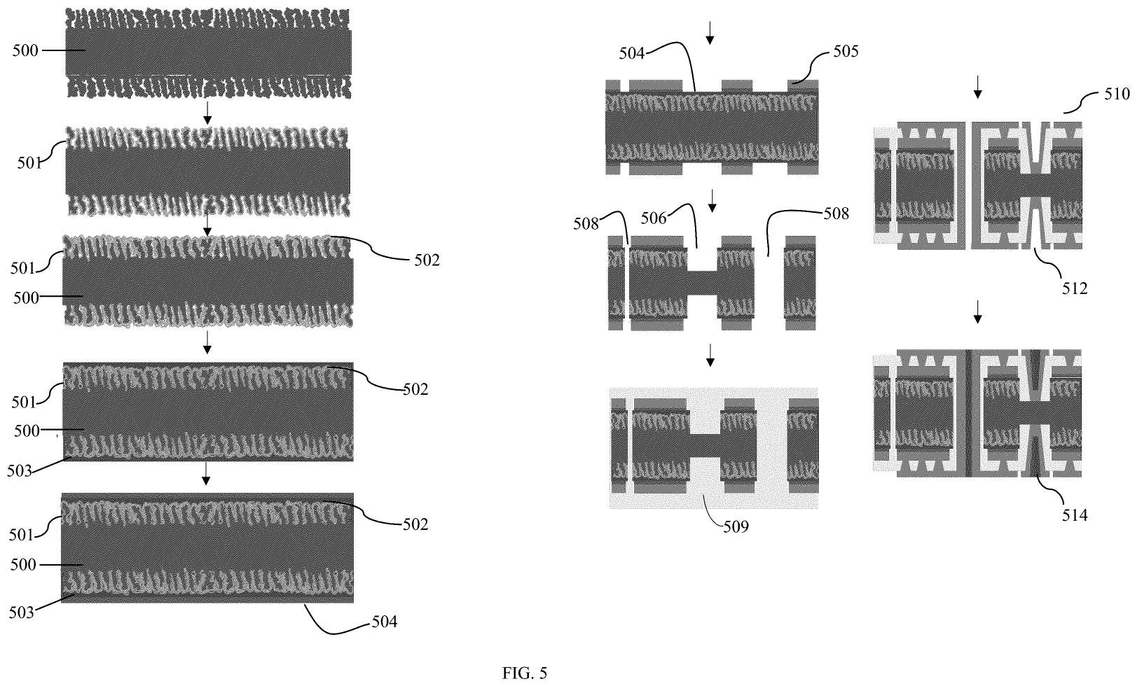

FIG. 5 illustrates, in diagrammatic form, an exemplary flow using the polymer free capacitor process to build an integrated capacitor with vertical power delivery, according to some embodiments. Certain improvements have been developed for use in semiconductor packaging related to integrated capacitors, specifically with respect to integrated capacitors with vertical power delivery, which improvements are fully described in the following pending application which is expressly incorporated herein in its entirety; “Semiconductor Package with Integrated Capacitors”, application Ser. No. 17/692,587, filed 17 Mar. 2022 (“Related Patent 1”). The polymer-free capacitor described above may be utilized as described in Related Patent 1, an example of which is illustrated in FIG. 5. As illustrated, the process begins with an aluminum foil electrode 500 etched according to at least one embodiment disclosed above to expand the effective surface area of the first electrode. The etched aluminum foil electrode 500, e.g., the anode, is then anodized, providing the dielectric layer 501 in accordance with the process described above. A low-viscosity particle-free conductive ink 502 is deposited on the dielectric layer 501, providing the base layer of the second electrode, e.g., the cathode. A low-viscosity particle-free conductive ink provides for deposition of the particle-free conductive ink into the various nooks and crannies of the etched aluminum electrode. Subsequent coats of particle-free conductive ink 503 are deposited to completely fill the space between the etched porous areas. A top-level metal seed 504, i.e., a copper (Cu) seed, is deposited by way of PVD, CVD, electroless plating, or printing/depositing another coat of particle-free ink. In some embodiments, top-level metal seed 504 could also be the final terminal of the capacitor device.

The cathode is patterned and plated by depositing copper (Cu) or analogous metals 505 on the copper seed 504. Through holes 508 or trenches 506 may then be formed in the capacitor by way of etching processes, such as through laser drilling methods. Capacitors are then isolated and laminated by way of ABF lamination 509. Laminated capacitors may then be plated 510 with anode and cathode connections, thus allowing for pattern connectivity to the RDL. Plating may be done in multiple steps to control plating thickness. Holes 512 are then plugged using copper (Cu) paste 514 to further lower ESR & DCR. The capacitor can then be integrated into a module for vertical power delivery.

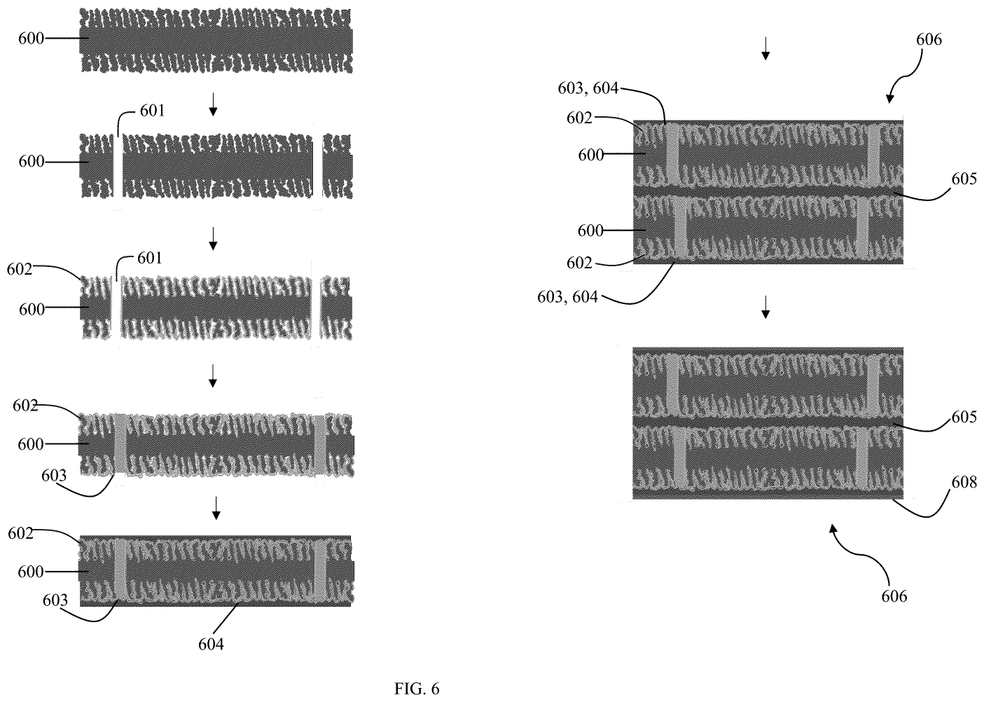

FIG. 6 illustrates, in diagrammatic form, an exemplary method of forming stacked multi-layer capacitor substrate for developing stacked thin-film capacitors with lower ESR, according to some embodiments. As illustrated in FIG. 6, the process begins with an aluminum foil electrode 600 etched according to at least one embodiment disclosed above to expand the effective surface area of the first electrode. Holes are drilled in the foil 600, providing for through-hole conductor paths 601 within the stacked multi-layer capacitor. The etched aluminum foil electrode 600 is then anodized, providing the dielectric layer 602 in accordance with the process described above. A low-viscosity particle-free conductive ink 603 is deposited on the dielectric layer 602, providing the base layer of the second electrode, e.g., the cathode, and filling the through-hole conductive paths 601. A low-viscosity Particle-free conductive ink provides for deposition of the Particle-free conductive ink into the various nooks and crannies of the etched aluminum electrode. Subsequent coats of Particle-free conductive ink of increasing viscosity 604 are deposited to completely fill the space between the etched porous areas. Multiple caps are then stacked to form a stacked capacitor structure 606, stacking with Particle-free conductive ink or metallic adhesives 605 according to some embodiments. A top-level metal seed 608, i.e., a copper (Cu) seed, is deposited by way of PVD, CVD, or electroless plating, where the Particle-free conductive ink is catalytically active for electroless plating. The exemplary embodiment illustrated here demonstrates the use of this process to build stacked capacitor substrates with internal electrode layers connected to the outer layers and may further be used to form integrated capacitors. Other embodiments are anticipated.

This patent focusses on the improvement to current capacitor substrates. In this case, a capacitor substrate is defined as a stack of 2 electrodes with a dielectric in between.

Note: While this all-metallic current collector stack will improve even traditional electrolytic capacitors, our application focus is package or board integrated capacitors. Integrated capacitors may need the capacitor substrate to be further ‘finished’ with patterning, metallization, isolation between voltage rails, etc. Chipletz has filed a patent Ref. P11056US00 February 2022 with claims on building integrated capacitors. The patent claimed here could use all of the integration techniques and methods claimed in the prior patent.

In this specification, example embodiments have been presented in terms of a selected set of details. However, a person of ordinary skill in the art would understand that many other example embodiments may be practiced which include a different selected set of these details. It is intended that the following claims cover all possible example embodiments.

Thus, it will be apparent to one of ordinary skill that this disclosure provides for improved method and apparatus for use in semiconductor packaging substrates for crack cessation and detection in semiconductor packaging substrates.

Apparatus, methods and systems according to embodiments of the disclosure are described. Although specific embodiments are illustrated and described herein, it will be appreciated by those of ordinary skill in the art that any arrangement which is calculated to achieve the same purposes can be substituted for the specific embodiments shown. This application is intended to cover any adaptations or variations of the embodiments and disclosure. For example, although described in terminology and terms common to the field of art, exemplary embodiments, systems, methods and apparatus described herein, one of ordinary skill in the art will appreciate that implementations can be made for other fields of art, systems, apparatus or methods that provide the required functions. The invention should therefore not be limited by the above-described embodiment, method, and examples, but by all embodiments and methods within the scope and spirit of the invention.

In particular, one of ordinary skill in the art will readily appreciate that the names of the methods and apparatus are not intended to limit embodiments or the disclosure. Furthermore, additional methods, steps, and apparatus can be added to the components, functions can be rearranged among the components, and new components to correspond to future enhancements and physical devices used in embodiments can be introduced without departing from the scope of embodiments and the disclosure. One of skill in the art will readily recognize that embodiments are applicable to future systems, future apparatus, future methods, and different materials.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

Terminology used in the present disclosure is intended to include all environments and alternate technologies that provide the same functionality described herein.

1. A stacked polymer-free electrolytic capacitor comprising:
a first electrode comprised of a first metal;
a dielectric deposed on said first electrode; and
a second electrode deposed formed on said dielectric, said second electrode comprising a metal-organic decomposition ink.

2. The stacked polymer-free electrolytic capacitor of claim 1 wherein said first electrode is further characterized as having an increased surface area.

3. The stacked polymer-free electrolytic capacitor of claim 2 wherein said increased surface area is by way of roughing a surface of said first electrode through chemical etching.

4. The stacked polymer-free electrolytic capacitor of claim 2 wherein said increased surface area is by way of sintering of metal particles to said first electrode.

5. The stacked polymer-free electrolytic capacitor of claim 2 wherein said increased surface area is by way of trenching using reactive ion etching of a core and subsequently utilizing a selected one of physical vapor deposition and chemical vapor deposition with electroplating of said first electrode.

6. The stacked polymer-free electrolytic capacitor of claim 1 wherein said dielectric deposition is further characterized as grown through an anodization process.

7. The stacked polymer-free electrolytic capacitor of claim 1 wherein said dielectric deposition is further characterized as deposed through physical vapor deposition.

8. The stacked polymer-free electrolytic capacitor of claim 1 wherein said dielectric deposition is further characterized as deposed through chemical vapor deposition.

9. The stacked polymer-free electrolytic capacitor of claim 1 wherein said second electrode formed on said dielectric comprising a metal-organic decomposition ink is further characterized as being formed by spray coating said metal-organic decomposition ink.

10. The stacked polymer-free electrolytic capacitor of claim 1 wherein said second electrode formed on said dielectric comprising a metal-organic decomposition ink is further characterized as being formed by dip coating said metal-organic decomposition ink.

11. The stacked polymer-free electrolytic capacitor of claim 1 wherein said second electrode formed on said dielectric comprising a metal-organic decomposition ink is further characterized as being formed by inkjet print said metal-organic decomposition ink.

12. A stacked polymer-free electrolytic capacitor comprising:
a first electrode comprised of a first metal;
a dielectric deposed on said first electrode;
a conductive polymer deposed on said dielectric; and
a second electrode deposed formed on said dielectric, said second electrode comprising a metal-organic decomposition ink.

13. The stacked polymer-free electrolytic capacitor of claim 12 wherein said first electrode is further characterized as having an increased surface area.

14. The stacked polymer-free electrolytic capacitor of claim 13 wherein said increased surface area is by way of roughing a surface of said first electrode through chemical etching.

15. The stacked polymer-free electrolytic capacitor of claim 13 wherein said increased surface area is by way of sintering of metal particles to said first electrode.

16. The stacked polymer-free electrolytic capacitor of claim 13 wherein said increased surface area is by way of trenching using reactive ion etching of a core and subsequently utilizing a selected one of physical vapor deposition and chemical vapor deposition with electroplating of said first electrode.

17. The stacked polymer-free electrolytic capacitor of claim 12 wherein said dielectric deposition is further characterized as grown through an anodization process.

18. The stacked polymer-free electrolytic capacitor of claim 12 wherein said dielectric deposition is further characterized as deposed through physical vapor deposition.

19. The stacked polymer-free electrolytic capacitor of claim 12 wherein said dielectric deposition is further characterized as deposed through chemical vapor deposition.

20. The stacked polymer-free electrolytic capacitor of claim 12 wherein said second electrode formed on said dielectric comprising a metal-organic decomposition ink is further characterized as being formed by spray coating said metal-organic decomposition ink.
